(19) United States
(12) Patent Application Publication
(10) Pub. No.: US 2008/0034022 A1
(43) Pub. Date: Feb. 7, 2008

(54) SYSTEM AND METHOD FOR UPDATING REFERENCES WHEN INCREMENTALLY COMPACTING A HEAP

(76) Inventor: Geoffrey O. Blandy, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/462,837

(22) Filed: Aug. 7, 2006

(51) Int. Cl. G06F 17/30

(52) U.S. Cl. 707/206

(57) ABSTRACT

A method, system, and computer-usable medium for updating references while incrementally compacting a heap. A compaction manager initializes each entry in a compaction data structure with a terminating value, where each entry within the compaction data structure corresponds to an address within a first compaction region. The compaction manager locates a first entry within the compaction data structure corresponding to the address of the first object. The compaction manager stores an address of the second object in the first entry and stores in the second object the value stored in the first entry. The compaction manager calculates a new address for the first object, traverses a chain of references starting with the first entry and updates the chain with the new address until encountering the terminating value, and moves the first object to the new address.

### BACKGROUND OF THE INVENTION

1. Technical Field

The present invention relates in general to the field of data processing systems. More specifically, the present invention relates to the field of memory management within data processing systems. Still more specifically, the present invention relates to a system and method for updating references when incrementally compacting a heap.

2. Description of the Related Art

Middleware components, such as that provided by a Java Virtual Machine (JVM), often use a heap to store objects created in the environment. The Java Virtual Machine's heap stores all objects created by a running Java application. Objects are created by various instructions, but are never freed (i.e., released) explicitly by the code. Garbage collection is the process of automatically freeing objects that are no longer referenced by the program.

The Java Virtual Machine specification does not require any particular garbage collection technique. The name “garbage collection” implies that objects no longer needed by the program are “garbage” and can be thrown away. A more accurate metaphor might be “memory recycling”. When an object is no longer referenced by the program, the heap space it occupies can be recycled so that the space is made available for subsequent new objects. The garbage collection must somehow determine which objects are no longer referenced by the program and make available the heap space occupied by such unreferenced objects.

In addition to freeing unreferenced objects, a garbage collection may also combat heap fragmentation. Heap fragmentation occurs through the course of normal program execution. New objects are allocated, and unreferenced objects are freed such that free portions of heap memory are left in between portions occupied by live objects. Requests to allocate new objects may have to be filled by extending the size of the heap even though there is enough total unused space in the existing heap. This will occur if there is not enough contiguous free heap space available into which the new object will fit. On a virtual memory system, the extra paging (or swapping) required to service an ever-growing heap can degrade the performance of the executing program. On an embedded system with lower memory capacity, fragmentation could cause the virtual machine to “run out of memory” unnecessarily. In addition, most virtual machines have a limit on the size of the heap. In these systems, fragmentation may cause premature garbage collection events that cause the application to stop running even though there is enough total free space in the heap. Also, depending on the object allocation scheme employed, the time to locate a suitable size piece of free memory may be greatly increased when a heap is fragmented.

Determining when to explicitly free allocated memory via garbage collection can be difficult. Delegating this task to the Java Virtual Machine has several advantages. First, it can increase programmer productivity. When programming in non-garbage-collected languages, a programmer can spend extensive amounts of time detecting and fixing elusive memory management problems.

A second advantage of garbage collection is that it helps ensure program integrity. Garbage collection is an important part of Java's security strategy. Java programmers are unable to accidentally (or purposely) crash the Java Virtual Machine by incorrectly freeing memory.

However, garbage collection adds processing overhead that can adversely affect program performance. The Java Virtual Machine has to keep track of which objects are being referenced by the executing program and free unreferenced objects during program execution. This activity generally consumes more CPU time than would be needed if the program explicitly freed unnecessary memory. In addition, programmers in a garbage-collected environment have less control over the scheduling of CPU time devoted to freeing objects that are no longer needed.

An additional challenge in managing a garbage-collected heap is that the heap periodically needs to be compacted in order to combat heap fragmentation. During compaction, objects are moved in order to defragment the heap space. When the heap space is defragmented, objects are moved to a contiguous memory region with little or no memory between the moved objects. The movement of objects results in larger contiguous blocks of free space that can be used to store additional objects. During the compaction of a traditional garbage-collected heap, the entire heap is traversed and many objects are moved within the heap. Heap sizes can be quite large and can store hundreds or thousands of objects. Consequently, moving such a large amount of objects takes considerable computing resources. The use of the resources to perform compaction often causes noticeable pauses to the user, as well as other software applications that are also executing on the system.

Those skilled in the art will appreciate that in compaction, the actual updating of the references to different objects must occur in a separate phase that follows the development of the new addresses. In the update phase, the new target address must be computed for every reference that is updated even though a single target may be referenced many times. The computation of the new address typically involves a lengthy look-up procedure utilizing break tables.

Accordingly, a system, method, and computer-usable medium is necessary for addressing the aforementioned limitations of the prior art.

### SUMMARY OF THE INVENTION

The present invention includes a method, system, and program product for updating references while incrementally compacting a heap. A compaction manager initializes each entry in a compaction data structure with a terminating value, where each entry within the compaction data structure corresponds to an address within a first compaction region. The compaction manager locates a first entry within the compaction data structure corresponding to the address of the first object. The compaction manager stores an address of the second object in the first entry and stores in the second object the value stored in the first entry. The compaction manager calculates a new address for the first object, traverses a chain of references starting with the first entry and updates the chain with the new address until encountering the terminating value, and moves the first object to the new address.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary data processing system in which a preferred embodiment of the present invention may be implemented;

FIG. 2 is a block diagram depicting exemplary contents of the system memory according to a preferred embodiment of the present invention;

FIG. 3A is a high-level logical flowchart diagram illustrating an exemplary program execution according to a preferred embodiment of the present invention;

FIG. 3B is a high-level logical flowchart diagram depicting an exemplary method of garbage collection according to a preferred embodiment of the present invention;

FIG. 3C is pseudocode illustrating an exemplary method of constructing a chain of references within the compaction phase in accordance with a preferred embodiment of the present invention;

FIG. 3D is pseudocode depicting an exemplary method of calculating a new address for each compaction object and updating the chain of references with the newly-calculated address in accordance with a preferred embodiment of the present invention;

FIG. 4A is a block diagram illustrating an exemplary heap according to a preferred embodiment of the present invention;

FIG. 4B is a block diagram depicting an exemplary heap and compaction data structure after initialization of the compaction data structure according to a preferred embodiment of the present invention;

FIG. 4C is a block diagram illustrating an exemplary heap and compaction data structure after constructing a chain of references according to a preferred embodiment of the present invention;

FIG. 4D is a block diagram depicting an exemplary heap and compaction data structure after updating references utilizing the chain of references according to a preferred embodiment of the present invention; and

FIG. 4E is a block diagram illustrating an exemplary heap and compaction data structure after moving the compaction objects to the newly-calculated addresses according to a preferred embodiment of the present invention.

### DETAILED DESCRIPTION OF A PREFERRED EMBODIMENT

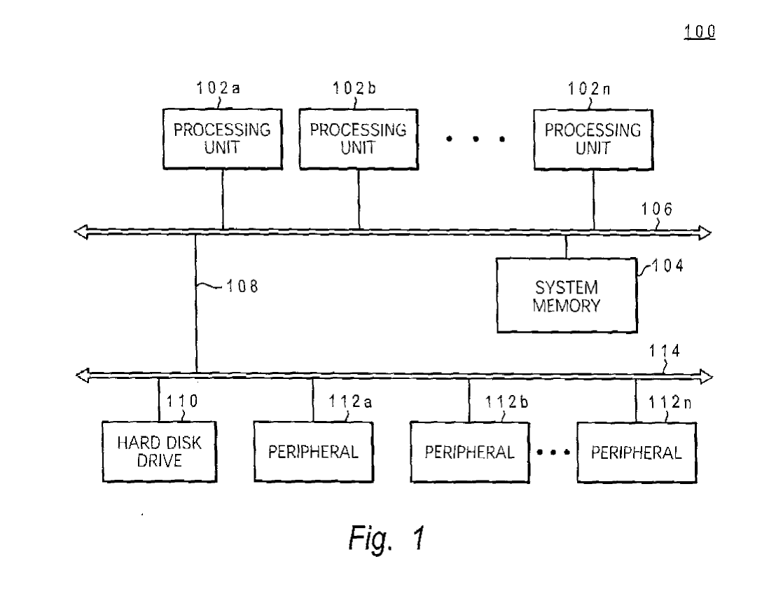

Referring to the figures, and more particularly, referring now to FIG. 1, there is illustrated a block diagram of an exemplary data processing system in which a preferred embodiment of the present invention may be implemented. As depicted, exemplary data processing system 100 includes processor(s) 102a-n, which are coupled to system memory 104 via system bus 106. Preferably, system memory 104 may be implemented as a collection of dynamic random access memory (DRAM) modules. Mezzanine bus 108 acts as an intermediary between system bus 106 and peripheral bus 114. Those with skill in this art will appreciate that peripheral bus 114 may be implemented as a peripheral component interconnect (PCI), accelerated graphics port (AGP), or any other peripheral bus. Coupled to peripheral bus 114 is hard disk drive 110, which is utilized by data processing system 100 as a mass storage device. Also coupled to peripheral bus 114 are a collection of peripherals 112a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 to incremental garbage collection of a heap provided by the present invention are applicable to data processing systems of any system architecture and are in no way limited to the generalized multi-processor architecture or symmetric multi-processing (SMP) architecture illustrated in FIG. 1.

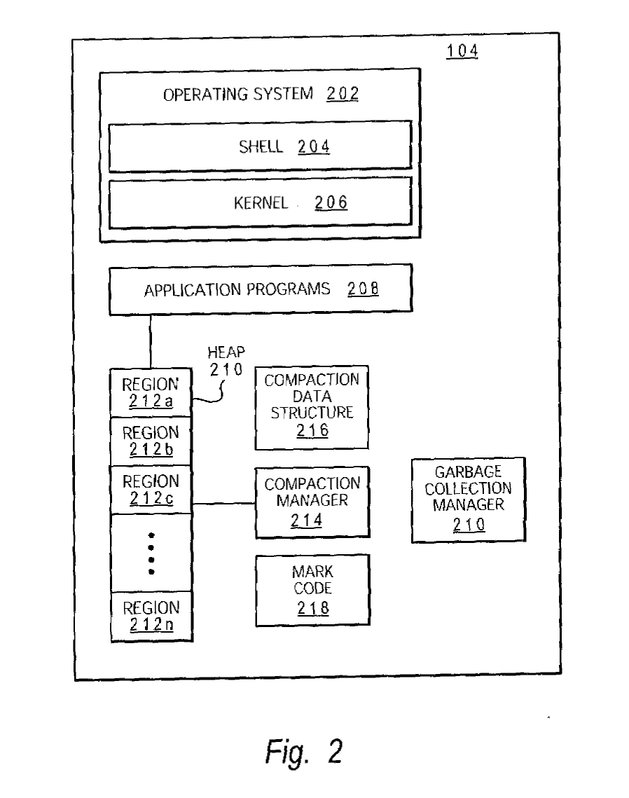

FIG. 2 is a block diagram illustrating exemplary contents of system memory 104 of data processing system 100, according to a preferred embodiment of the present invention. As illustrated, system memory 104 includes operating system 202, which further includes shell 204 for providing transparent user access to resources of data processing system 100. Generally, shell 204 is a program that provides an interpreter and an interface between the user and the operating system. More specifically, shell 204 executes commands that are entered into a command line user interface or a file. Thus, shell 204 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

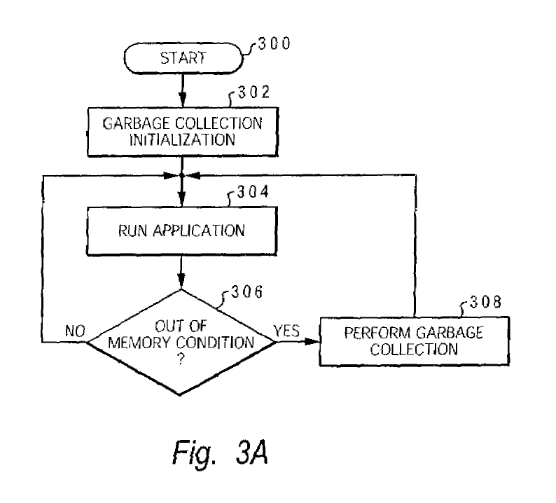

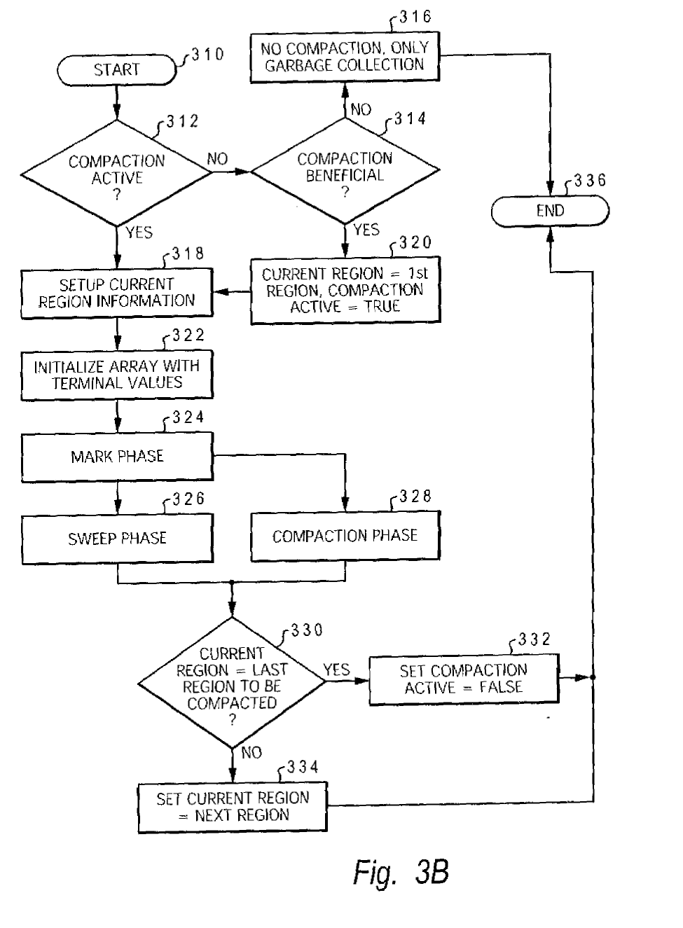

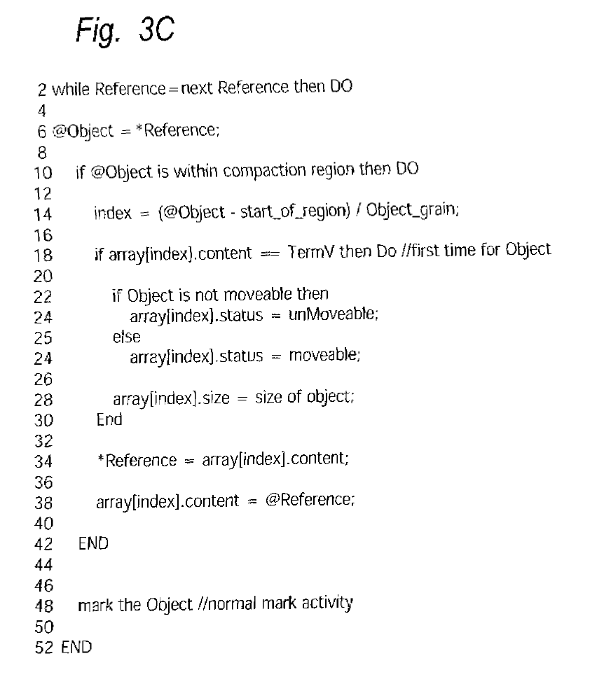

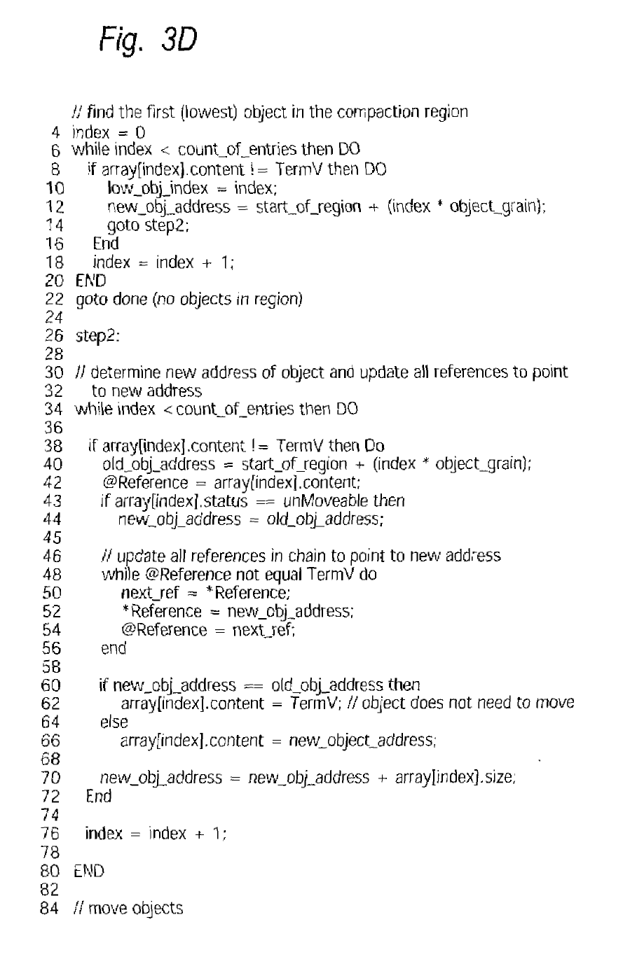

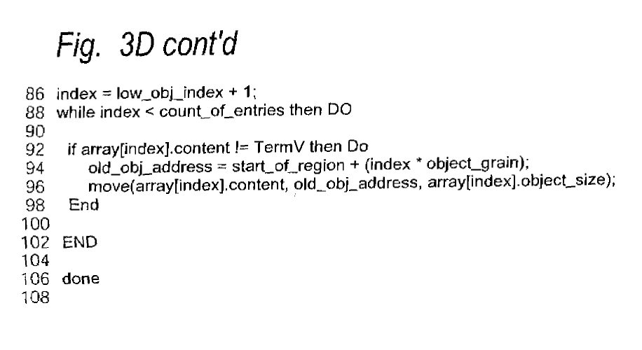

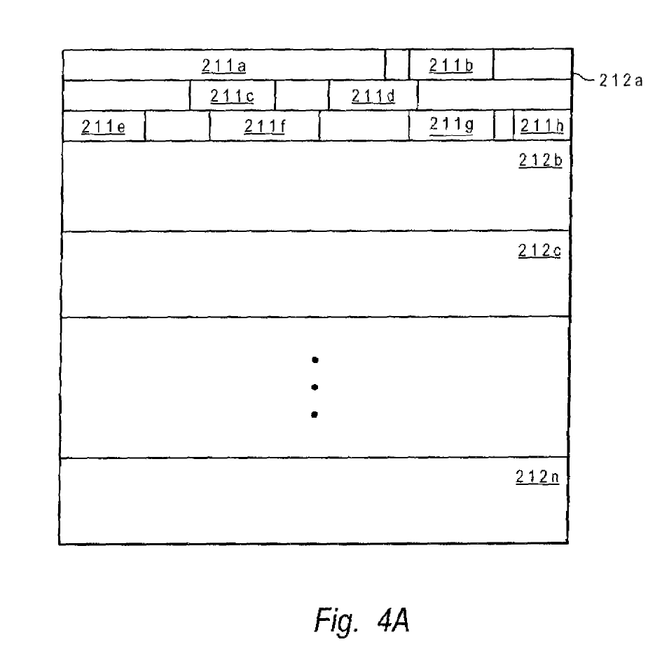

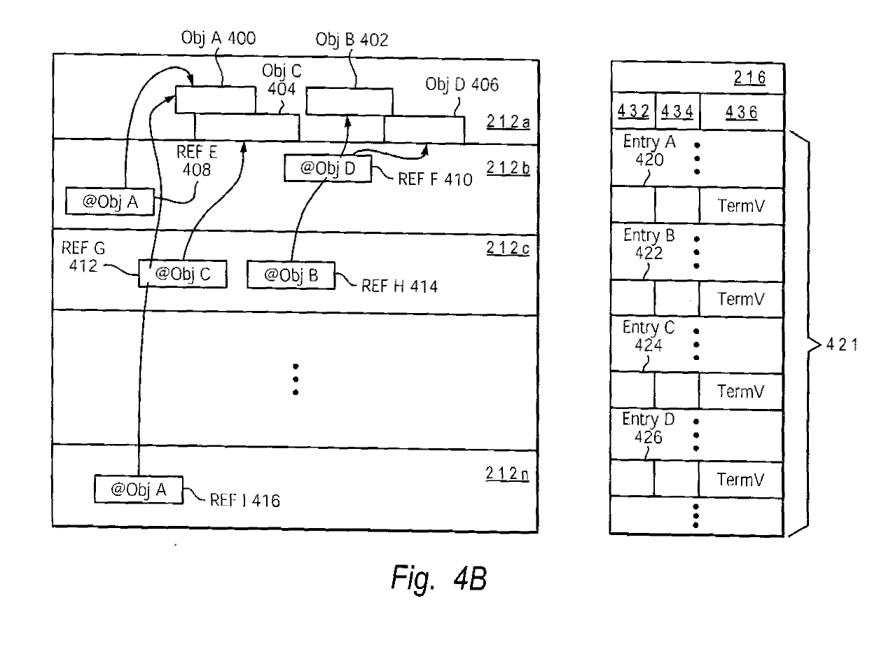

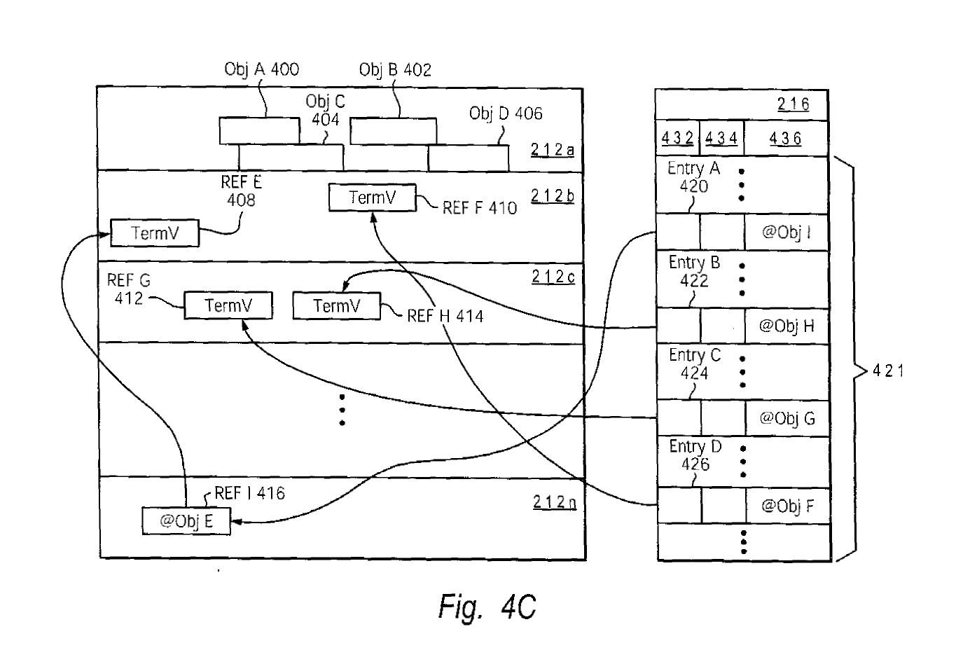

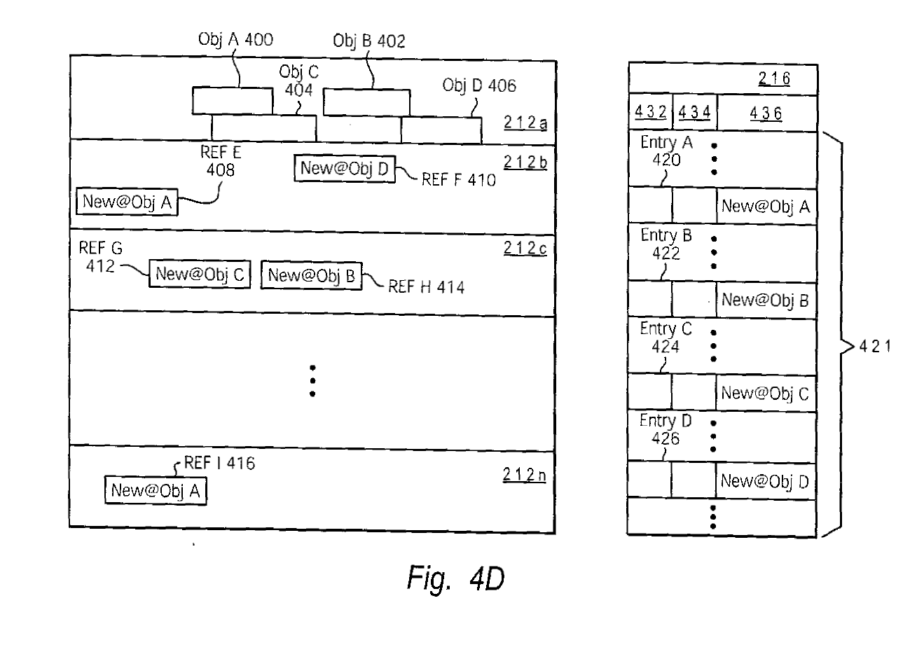

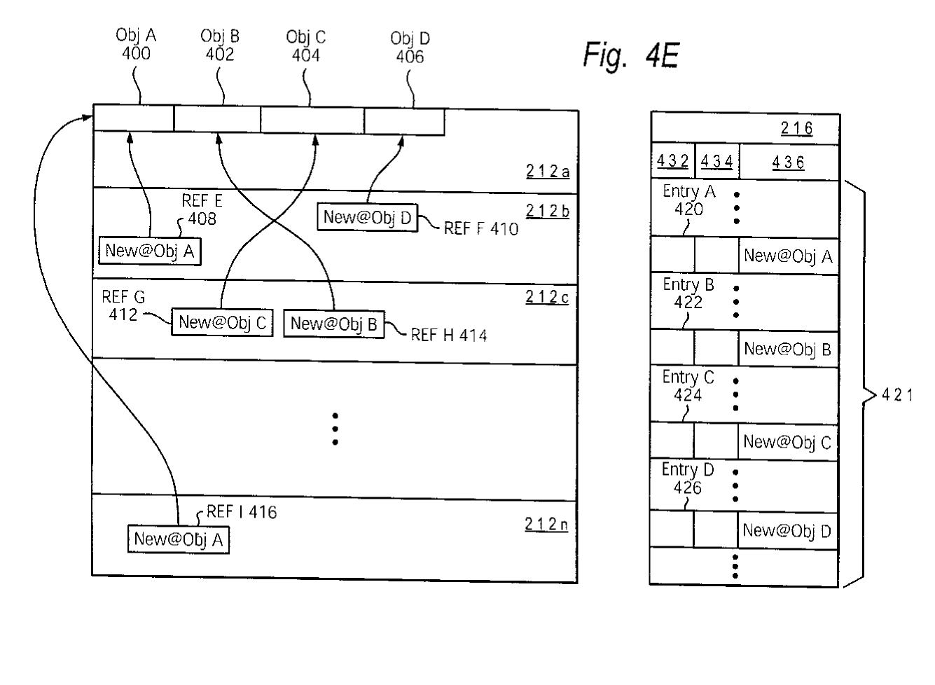

As illustrated, operating system 202 also includes kernel 206, which includes lower levels of functionality for operating system 202, including providing essential services required by other parts of operating system 202 and application programs 208, including memory management, process and task management, disk management, and mouse and keyboard management. Application programs 208 can include a browser, utilized for access to the Internet, word processors, spreadsheets, and other application programs. Also, as depicted in FIG. 2, system memory 104 includes heap 210 (subdivided into regions 212a-n), compaction data structure 216, mark code 218, and compaction manager 214. If compaction manager 214, in conjunction with mark code 218, determines that heap 210 requires compaction, compaction manager 214 performs incremental compaction on heap 210, which is described in more detail in conjunction with FIGS. 3A-3D and FIGS. 4A-4E.

To understand the terminology that will be used hereafter, assume that there is an object “x” and that there is a storage location “z” that contains the address of object x. We refer to object “x” as “Object x” and to the address of object x as “@Object x”. Storage location “z” is an “object reference” and shall be referred to as “Reference z”. The address of storage location “z” will be referred to as “@Reference z”. The content of Reference z (the address of the object) is refered to as “*Reference z”. An “object grain” is the minimum alignment in bytes for the start of an object.

The figures utilize the abbreviations “Obj” and “Ref” in place of “Object” and “Reference”. The examples depicted in the figures only show object references that reside in heap 210 (i.e., fields within live objects that contain object addresses). Those skilled in the art will appreciate that object references may appear in other locations such as the program stack, global variables and the saved register set.

FIG. 3A is a high-level logical flowchart illustrating an exemplary program execution according to a preferred embodiment of the present invention. Generally, an application program (e.g., one of application programs 208) utilizes heap 210 as memory storage during the execution of the application program. Periodically, heap 210 encounters an out-of-memory condition during program execution and requires compaction manager 214, mark code 218, and garbage collection manager 220 to remove unused objects and rearrange “live” objects within heap 210 to create more contiguous free space. As illustrated in FIG. 4A, heap 210 includes a region 212a that further includes fragmented objects.

As illustrated in FIG. 3A, the process begins at step 300 and proceeds to step 302, which illustrates garbage collection manager 220 performing garbage collection initialization. In a preferred embodiment of the present invention, garbage collection initialization may include, but is not limited to, allocating a compaction data structure 216 for later use and dividing heap 210 into compaction regions (e.g., regions 212a-n). The process continues to step 304, which illustrates data processing system 100 executing or running the application. Step 306 illustrates a determination made as to whether the application has encountered an “out-of-memory” condition during execution. If an “out-of-memory” condition has not been encountered, the process returns to step 304 and proceeds in an iterative fashion. If an “out-of-memory” condition is encountered, the process continues to step 308, which illustrates garbage collection manager 220, compaction manager 214, and mark code 218 performing garbage collection within regions 212a-n. The process returns to step 304 and proceeds in an iterative fashion.

FIG. 3B is a high-level logical flowchart of an exemplary method of garbage collection according to a preferred embodiment of the present invention. As illustrated, the process begins at step 310 and continues to step 312, which illustrates compaction manager 214 determining if compaction is active in the current garbage collection cycle. Those with skill in the art will appreciate that the determination of whether compaction is active can be managed by a “compaction active” variable (e.g., Boolean, etc.) stored in system memory 104. If the “compaction active” variable is set to “true”, compaction is active for the current garbage collection cycle. If the “compaction active” variable is set to “false”, compaction is not active for the current garbage collection cycle.

If the “compaction active” variable is set to false, compaction manager 214 determines if compaction of heap 210 is beneficial to the current garbage collection cycle, as depicted in step 314. If compaction of heap 210 is not beneficial (e.g., would not significantly improve the performance of application execution, etc.), the process continues to step 316, which illustrates garbage collection manager 220 performing garbage collection without compaction. The process ends, as illustrated in step 336.

Returning to step 314, if compaction manager 214 determines that compaction would be beneficial to the current garbage collection cycle, the process continues to step 320, which depicts a pointer within compaction manager 214 designating a first region (e.g., region 212a) of heap 210 to be the current region for compaction and set the “compaction active” variable to “true”. The process continues to step 318.

Returning to step 312, if compaction manager 214 determines that the “compaction active” variable is set to “true”, the process continues to step 318, which depicts setting up the current region information. For example, compaction manager 214 may examine the current region to be compacted (e.g., region 212a), determine the size of the region, and set up a compaction data structure 216 of a size proportional to the size of the region to be compacted. In another preferred embodiment of the present invention, compaction manager 214 may accomplish the step of setting up compaction data structure 216 during garbage collection initialization (step 302 in FIG. 3A).

The process continues to step 322, which illustrates compaction manager 214 initializing compaction data structure 216 with terminal values, depicted as “TermV” in FIGS. 4B-4C. The terminal values (e.g., TermV) designate the end of a “chain of references”, discussed herein in more detail.

The process proceeds to step 324, which illustrates mark code 218 performing the mark phase when compaction is active. The mark phase in a garbage collection cycle entails mark code 218 scanning the heap for objects (also called “live objects”) that include object references. For example, referring to FIG. 4B, Object A 400 is considered a “live object” because Object A 400 has two object references, which are two fields that include object addresses of Object A 400: Reference E 408 within region 212b and Reference I 416 within region 212n.

The process continues to steps 326 and 328, which are processed in parallel and depict a sweep phase (step 326) and a compaction phase (step 328). The sweep phase illustrated in step 326 involves garbage collection manager 220 identifying the free space between “live” objects that will be used for future allocations. The compaction phase depicted in step 328 includes calculating new addresses, creating a chain of references, and moving the objects within the compaction region to new locations.

The process continues to step 330, which illustrates compaction manager 214 determining if the current region is the last region to be compacted within heap 210. If the current region is not the last region to be compacted, compaction manager 214 sets its “current region” pointer to the next region in heap 210, as illustrated in step 334 and the process ends, as depicted in step 336. Returning to step 330, if compaction manager 214 determines that the current region is the last region to be compacted within heap 210, compaction manager 214 sets the compaction active variable to “false” and the process ends, as illustrated in step 336.

During the discussion of pseudocode in FIGS. 3C-3D, various structures depicted in FIGS. 4A-4E will be referenced, specifically, compaction data structure 216, which includes array 421, size field 421, status field 434, and content field 436. Compaction manager 214 utilizes compaction data structure 216 to perform garbage collection and compaction on heap 210.

FIG. 3C is pseudocode that illustrates the logic performed during the mark phase represented by step 324 of FIG. 3B in accordance with a preferred embodiment of the present invention. The process begins with line 2, which shows the mark phase locating the next object reference. On line 6, the content of the object reference is placed in temporary variable @Object. At line 10, a determination is made as to whether @Object lies within the compaction region. If so the process continues at line 14, which develops the index of the entry in array 421 within compaction data structure 216 that corresponds to Object. On line 18, content field 436 of the array entry is examined to determine if this is the first time a reference to this object has been detected during this mark phase. This is done by comparing content field 436 to TermV, the initialized value of the field. For first time references, the process continues with lines 22 to 24 where status field 434 is set to indicate if the object is moveable. At line 28, size field 432 of the entry is set to the size of the object and the process proceeds to line 34. Returning to line 14, if the content field is not equal to TermV, the process proceeds to line 34. Line 34 shows the content of the object reference being set to the value of the content field of the array entry. Then on line 38, content field 436 of the array entry is set to the address of the object reference. The process continues at line 48. Returning to line 10, if the object is not in the compaction region the process continues at line 48. Line 48 shows that the normal marking activity is performed for Object as is necessary regardless of whether compaction is active. The process continues from line 2 in an iterative fashion until all object references have been processed.

FIG. 3D is pseudocode that represents the steps performed in the compaction phase. The compaction phase involves developing the new address of each compaction object, updating each Reference with the new address and finally moving the compaction object to its new location. Note that the objects cannot be moved until after all References have been updated as some of the References could be contained in object(s) within the compaction region.

Referring to FIG. 3D, lines 4 through 22 examine the compaction array looking for the compaction object with the lowest address. The process starts with line 4, where an index to array 421 is initialized to zero. Line 6 determines by reference to the index if the end of array 421 has been reached. If not, line 8 is reached, and content field 436 of the current array entry identified by the index is compared to TermV, the terminal value. If they are not equal, the first compaction object has been located and the process continues with line 10, where the index of the entry representing this first object is saved. Then at line 12, new_obj_address is set to point to the end of the first object, and the process continues with line 14, which directs the flow to line 34 via the label at line 26. Returning to line 8, if content field 436 of the current array entry is equal to TermV, the process continues to line 18, which increments the index and then returns to line 6 in an iterative fashion. Returning to line 6, if all content fields 436 of all entries are equal to TermV, the compaction phase completes (line 22) having found no compaction objects.

Otherwise the process continues at line 34, which like line 6, makes a determination by reference to the index as to whether there are more entries to process. Note that the index now addresses the entry for the first compaction object and new_obj_address contains the address of that compaction object. The process continues at line 38 where the current entry is examined to determine if it represents a compaction object. If not (i.e., content field 436 contains TermV), the index is incremented at line 76, and the process returns to line 34 and proceeds in an iterative fashion. If at line 38, content field 436 is found to be not equal to TermV, it must contain the address of an object reference (@Reference). In this case, the process continues with line 40, where the old address of the object is computed, and then to line 42 where @Reference is loaded from the content field. Then lines 48 through 56 illustrate that each Reference is updated with the new object address. Line 48 checks for the terminal value that identifies the end of the chain. Line 50 saves the current content of the Reference and line 52 sets the reference to point to the new address. Line 51 loads @Reference with the address of the next Reference in the chain or TermV if the end is reached.

After updating all references, line 60 shows that if the object does not need to be moved (i.e., new_obj_address is the same as old_obj_address) the content field is set to TermV (line 62). Otherwise the content field is set to the new_object_addresss at line 66. Then at line 70 the new_obj_address is adjusted to account for the current object and the process continues with line 76 where the index is incremented and then back to the top of the loop at line 34.

After all entries have been processed, the objects are moved as described in lines 86 to 102. Line 86 sets the index to the entry following the one that represents the first compaction object. Line 88 checks for the end of the array, terminating the process when it is reached. Line 92 checks to see if there is an object to be moved and if so line 94 develops the current address of the object and line 96 calls the move function which moves the object to its new location. The process iterates until all entries within array 421 have been processed.

FIGS. 4A-4E illustrate heap 210 and compaction data structure 216 in various stages of program execution. FIG. 4A illustrates heap 210 before a garbage collection cycle. Note that region 212a includes Objects 211a-h arranged in a fragmented manner. FIG. 4B depicts heap 210 and compaction data structure 216 before a garbage collection cycle, after array 421 within compaction data structure 216 has been initialized with a TermV in content field 436 (FIG. 3B, step 322). Note that References E, F, G, and H 408-414 refer to Objects A, B, C, D 400-406 and Reference I 416 also refers to Object A 400. FIG. 4C depicts heap 210 and compaction data structure 216 during a garbage collection cycle, after the chain of references have been formed (FIG. 3C, lines 34-38). FIG. 4D illustrates heap 210 and compaction data structure 216 after References E, F, G, H, and I 408-416 have been updated with the new addresses for Objects A, B, C, and D 400-406 (FIG. 3D, lines 30-82). FIG. 4E depicts heap 210 and compaction data structure 216 after compaction manager 214 has moved Objects A, B, C, and D 400-406 to the new locations (FIG. 3D, lines 84-108).

Those with skill in the art will appreciate that the present invention may include implementation in multi-threaded garbage collection systems. In another preferred embodiment of the present invention, each thread in a multi-threaded system includes a local queue of references. During the mark phase illustrated in step 324 in FIG. 3B, when a mark thread, which may be implemented as mark code 218, encounters an object address within the compaction region, the mark thread pushes the address of the object reference (“@object reference”) onto the local queue. When the local queue becomes full (and at the completion of the mark phase), a lock is acquired to serialize access to compaction data structure 216 and each entry within compaction data structure 216 is processed as described in FIGS. 3A-3E. Also when running with multiple threads, the compaction region is subdivided so that each thread has a private section to work on. The process described in FIG. 3D can then continue without the need for further serialization.

As discussed, the present invention includes a method, system, and program product for updating references while incrementally compacting a heap. A compaction manager initializes each entry in a compaction data structure with a terminating value, where each entry within the compaction data structure corresponds to an address within a first compaction region. The compaction manager locates a first entry within the compaction data structure corresponding to the address of the first object in response to the first object is stored within the compaction region. The compaction manager stores an address of the second object in the first entry and stores in the second object the value stored in the first entry. The compaction manager calculates a new address for the first object, traverses a chain of references starting with the first entry and updates the chain with the new address until encountering the terminating value, and moves the first object to the new address.

It should be understood that at least some aspects of the present invention may alternatively be implemented as a program product. Program code defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A method for re-referencing memory including a first object and a second object, wherein said second object includes an address of said first object, said method comprising:
initializing each entry in a compaction data structure with a terminating value, wherein each entry within said compaction data structure corresponds to an address within a first compaction region;
in response to determining that at least said first object is stored within said compaction region, locating a first entry within said compaction data structure corresponding to said address of said first object;
creating a chain of references by:
storing an address of said second object in said first entry; and
storing in said second object a value stored in said first entry;
calculating a new address for said first object;
traversing said chain of references starting with said first entry and updating said chain with said new address until encountering said terminating value; and
moving said first object to a location specified by said new address.

2. The method according to claim 1, further comprising:
if compaction is not active and not beneficial, performing only a garbage collection function.

3. The method according to claim 1, further comprising:
determining if said first object is movable; and
in response to determining said first object is not movable, setting a new object address for said first object equal to the current object address for said first object.

4. The method according to claim 3, further comprising:
in response to determining said first object is movable, setting said new object address for said first object equal to a start of said compaction region plus an index of said first entry times an object grain value.

5. The method according to claim 4, wherein said object grain value is a minimum alignment in bytes for a start of an object.

6. A data processing system for re-referencing memory including a first object and a second object, wherein said second object includes an address of said first object, said data processing system comprising:
a processor;
an interconnect coupled to said processor; and
a system memory coupled to said interconnect, wherein said system memory further includes:
a compaction manager for initializing each entry in a compaction data structure with a terminating value, wherein each entry within said compaction data structure corresponds to an address within a first compaction region, in response to determining that at least said first object is stored within said compaction region, locating a first entry within said compaction data structure corresponding to said address of said first object, creating a chain of references by: storing an address of said second object in said first entry, and storing in said second object a value stored in said first entry, calculating a new address for said first object, traversing said chain of references starting with said first entry and updating said chain with said new address until encountering said terminating value, and moving said first object to a location specified by said new address.

7. The data processing system system according to claim 6, further including:
a garbage collection manager for performing only a garbage collection function, if compaction is not active and not beneficial.

8. The data processing system according to claim 6, further including:
mark code for determining if said first object is movable and in response to determining said first object is not movable, setting a new object address for said first object equal to the current object address for said first object.

9. The data processing system according to claim 8, wherein said mark code sets said new object address for said first object equal to a start of said compaction region plus an index of said first entry times an object grain value.

10. The data processing system according to claim 9, wherein said object grain value is a minimum alignment in bytes for a start of an object.

11. A computer-usable medium embodying computer program code, said computer program code for re-referencing memory including a first object and a second object, wherein said second object includes an address of said first object, said computer program code comprising computer-executable instructions configured for:
initializing each entry in a compaction data structure with a terminating value, wherein each entry within said compaction data structure corresponds to an address within a first compaction region;
in response to determining that at least said first object is stored within said compaction region, locating a first entry within said compaction data structure corresponding to said address of said first object;
creating a chain of references by:
storing an address of said second object in said first entry; and
storing in said second object a value stored in said first entry;
calculating a new address for said first object;
traversing said chain of references starting with said first entry and updating said chain with said new address until encountering said terminating value; and
moving said first object to a location specified by said new address.

12. The computer-usable medium according to claim 11, wherein said embodied computer program code further comprises computer-executable instructions configured for:
determining if said first object is movable; and
in response to determining said first object is not movable, setting a new object address for said first object equal to the current object address for said first object.

13. The computer-usable medium according to claim 11, wherein said embodied computer program code further comprises computer-executable instructions configured for:
in response to determining said first object is movable, setting said new object address for said first object equal to a start of said compaction region plus an index of said first entry times an object grain value.

14. The computer-usable medium according to claim 13, wherein said embodied computer program code further comprises computer-executable instructions configured for:
in response to determining said first object is movable, setting said new object address for said first object equal to a start of said compaction region plus an index of said first entry times an object grain value.

15. The computer-usable medium according to claim 14, wherein said object grain value is a minimum alignment in bytes for a start of an object.
